(19) United States
(12) Patent Application Publication
(10) Pub. No.: US 2005/0240953 A1
(43) Pub. Date: Oct. 27, 2005

(54) Information recording and reproducing apparatus

(75) Inventor: Hiroyuki Awano, Noda (JP)

Correspondence Address: OLIFF & BERRIDGE, PLC, P.O. BOX 19928, ALEXANDRIA, VA, 22320, US

(73) Assignee: Hitachi Maxell, Ltd., Ibaraki-shi (JP)

(21) Appl. No.: 11/073,840

(22) Filed: Mar. 8, 2005

(30) Foreign Application Priority Data
Apr. 16, 2004 (JP) 2004-121643

(51) Int. Cl. G11B 7/08

(52) U.S. Cl. 720/670

(57) ABSTRACT

An information recording and reproducing apparatus that is smaller in size, high in disk exchange speed, loaded with optical disks and large in capacity is provided by providing an information recording and reproducing apparatus comprising a cartridge loaded with optical disks, a head for recording information on and reproducing information from one of the optical disks, a spindle for rotating the optical disk, and a first robot arm for carrying the optical disk between the cartridge and the spindle, the first robot arm being variable in length, the cartridge being expandable and contractible in a direcition perpendicular to the surface of the optical disk.

### BACKGROUND OF THE INVENTION

1. Field of the Invention

The present invention relates to an information recording and reproducing apparatus. More specifically, the present invention relates to an information recording and reproducing apparatus, in which a plurality of optical disks are loaded, to enable recording and reproduction of a large amount information.

2. Description of the Related Art

In recent years, the recording density of external strage device for storing enormous information has been remarkably improved with the development of the informational society. At present, what is mainly used as external strage device for the business and the people's livelihood is hard disk drive, while optical disk and magnetic disk are used for archive and backup of information. Magnetic tape is much larger in storage capacity than optical disk, and the bit cost of magnetic tape is lower than that of optical disk. Accordingly, the mainstream system for the business is combinations of hard disk and magnetic tape. For the people's livelihood, optical disk is used oftener than magnetic tape from the point of view of handiness and random accessibility.

A magnetic tape is lower in surface recording density than an optical disk, but the substrate of a magnetic tape is thinner than that of an optical disk, and a magnetic tape is larger in surface area than an optical disk. Consequently, a magnetic tape is one digit larger in storage capacity per cartridge than an optical disk. However, because an optical disk is advantageous in random accessibility, conservation, handiness, etc., there is a large demand for larger capacity of an optical disk.

### SUMMARY OF THE INVENTION

It is conceivable that an optical disk can be equivalent in storage capacity to a magnetic tape by a method of loading a plurality of optical disks into an information recording and reproducing apparatus. As stated above, a magnetic tape is one digit larger in storage capacity per cartridge than an optical disk. Accordingly, for example, an equivalent storage capacity with a magnetic tape is accomplished by loading ten optical disks in an information recording and reproducing apparatus. However, for example, one of the presently used large-capacity magnetic tapes is LTO (linear tape-open). The size of an LTO drive is about 14 cm×22 cm×8 cm. By contrast, for example, an information recording and reproducing apparatus in which the cartridge is loaded with 10 ordinary optical disks requires a CD changer (refer, for example, to Japanese Patent Application Laid-open No. 2003-141805) for carrying an optical disk from the cartridge to the spindle. As a result, the information recording and reproducing apparatus is much larger in size than an LTO drive. In Addition such an information recording and reproducing apparatus has another problem that it takes more time to exchange optical disks when loading an optical disk on and unloading an optical disk from the spindle motor.

The present invention has been made to solve the foregoing problems. A first object of the present invention is to reduce the size of the information recording and reproducing apparatus loaded with optical disks, and to increase the disk exchange speed. A second object of the present invention is to increase the capacity of the information recording and reproducing apparatus by loading more optical disks therein.

According to a first aspect of the present invention, an information recording and reproducing apparatus is provided that comprises:

a cartridge in which a plurality of optical disks are loaded;

a head which records information on and reproduces information from one of the optical disks;

a spindle which rotates the optical disk; and

a first arm which carries the optical disk between the cartridge and the spindle, and which expandable and contractible in a longitudinal direction thereof.

According to a second aspect of the present invention, an information recording and reproducing apparatus is provided that comprises:

a cartridge in which a plurality of optical disks are loaded;

a head which records information on and reproduces information from one of the optical disks;

a spindle which rotates the optical disk; and

a first arm which carries the optical disk between the cartridge and the spindle;

the cartridge is expandable and contractible in a direction of a rotational axis of the spindle.

The information recording and reproducing apparatus according to the second aspect of the present invention may further comprise an expansion-contraction unit which expands and contracts the cartridge, and a cartridge control unit which controls the expansion and contraction of the cartridge through the expansion-contraction unit when the cartridge is loaded into and unloaded from the information recording and reproducing apparatus.

The information recording and reproducing apparatus according to each of the first and second aspects of the present invention may further comprise a first support unit which supports the first arm, a first drive unit which moves the first arm in a direction of a rotational axis of the spindle, and a first control unit which controls an action of the first arm through the first support unit and the first drive unit when the optical disk is carried between the cartridge and the spindle. In the information recording and reproducing apparatus according to each of the first and second aspects of the present invention, a front end portion of the first arm may be provided with a first hold unit which holds the optical disk, and a thickness of the front end portion of the first arm may be thinner than the interval between the optical disks adjacent to each other in the cartridge.

The information recording and reproducing apparatus according to each of the first and second aspects of the present invention may further comprise a second arm which carries the optical disk between the cartridge and the spindle. The information recording and reproducing apparatus according to each of the first and second aspects of the present invention may further comprise a second support unit which supports the second arm, a second drive unit which moves the second arm in the direction of the rotational axis of the spindle, and a second control unit which controls an action of the second arm through the second support unit and the second drive unit when the optical disk is carried between the cartridge and the spindle. In the information recording and reproducing apparatus according to each of the first and second aspects of the present invention, a front end portion of the second arm may be provided with a second hold unit which holds the optical disk, and a thickness of the front end portion of the second arm may be thinner than the interval between the optical disks adjacent to each other in the cartridge.

In the information recording and reproducing apparatus according to each of the first and second aspects of the present invention, while information is recorded on and/or reproduced from a predetermined optical disk, the first and second control units may control the actions of the first and second arms, respectively, so that one of the arms holds the optical disk for the next recording and/or reproduction and stands by.

In the information recording and reproducing apparatus according to each of the first and second aspects of the present invention, while the optical disks are exchanged, the first and second control units may cooperate with each other to control the actions of the first and second arms, respectively, so that each of the arms avoids interfering with the other's action.

The optical disks loaded in the cartridges in the information recording and reproducing apparatus according to the first and second aspects of the present invention may be optical disks used in a magnetic domain-expanding reproduction system. In the optical disk used in a magnetic domain-expanding reproduction system, even though information is recorded in minute recording magnetic domain, the recorded information can be reproduced with the recording magnetic domain expanded. Accordingly, In the optical disk used in a magnetic domain-expanding reproduction system, information can be recorded more densely, so that they can be larger in capacity. It is preferable to use the magnetic domain-expanding type reproduction disk including a thin substrate that has a thickness of 50-500 micrometers (μm) as shown in Japanese Patent Application Laid-open No. 2001-35008, for example. It is preferable that the thickness of the optical disk loaded in the cartridges in the information recording and reproducing apparatus according to the first and second aspects of the present invention be thinner for larger capacity. It is particularly preferable that the thickness of this disk be 100 micrometers or less.

An example of the information recording and reproducing apparatus of the present invention will be described with reference to FIGS. 1-7. FIGS. 1A and 1B are a schematic plan view and a schematic sectional view, respectively, of the information recording and reproducing apparatus of the present invention. As shown in FIGS. 1A and 1B, the information recording and reproducing apparatus 100 of the present invention consists mainly of a cartridge 200, heads 12, a spindle 16, a first arm 301 and a second arm 302. The cartridge 200 is loaded with optical disks 10. The heads 12 record information on and reproduce information from an optical disk 10. The spindle 16 rotates an optical disk 10. The first arm 301 and second arm 302 carry optical disks 10 between the cartridge 200 and spindle 16. Although the example shown in FIG. 1 is an information recording and reproducing apparatus having two arms, the present invention is not limited to this, but a single arm may carry an optical disk.

The information recording and reproducing apparatus of the present invention selects a desired optical disk out of the optical disks loaded in the cartridge. A telescopic arm carries the selected optical disk onto the spindle. When recording or reproduction for the selected optical disk ends, the arm carries the optical disk on the spindle to the cartridge.

As shown in FIG. 1A, the cartridge 200 and spindle 16 are spaced from each other so that the optical disk set on the spindle 16 does not overlap with the optical disks stored in the cartridge 200. Each of the first and second arms 301 and 302 is attached on a support 307, which is shown in FIG. 6 (not shown in FIG. 1A). In the example shown in FIG. 1, the supports 307 for the arms are disposed near the top and bottom of the information recording and reproducing apparatus 100 in the planed FIG. 1A, and relatively near the spindle 16. The supports 307 are disposed so as not to overlap with the optical disk set on the spindle 16 and the optical disks stored in the cartridge 200. However, the present invention is not limited to this. The positions of the supports for the arms are arbitrary as far as the supports do not overlap with the optical disk set on the spindle and the optical disks stored in the cartridge. The positions of the supports for the arms in the information recording and reproducing apparatus may vary suitably with the size of this recording and reproducing apparatus, the form of the cartridge, the positional relationships among components, etc.

The cartridge (or the case) of the information recording and reproducing apparatus of the present invention may have a fixed form. However, as shown, for example, in FIG. 2, it is preferable that the size of the cartridge 200 expandable and contractible in the direction perpendicular to the surface of the optical disk loaded in the cartridge (the direction along the rotational axis of the optical disk) so that the optical disk is easy to take out and store therein. FIG. 2 is schematic sectional views (along line A-A in FIG. 1A) of the cartridge as seen from its side adjacent to the spindle. The cartridge 200 shown in FIG. 2 consists of an upper lid 201, a lower lid 202 and a disk holder 203, which is fitted to the lids 201 and 202. The disk holder 203 is stored with optical disks 10.

As shown in FIGS. 1B and 2B, the cartridge 200 shown in FIG. 2 has a structure that opens upward and downward when it is set in the information recording and reproducing apparatus 100. This structure makes it possible to widen the intervals between the optical disks loaded in the cartridge 200, as will be stated later on. This, in turn, makes it very easy to take out an optical disk from and put an optical disk in the cartridge 200. When the cartridge 200 opens as shown in FIG. 2B, its lower lid 202 may be opened with its upper lid 201 fixed, or vice versa. Alternatively, the lids 201 and 202 of the cartridge 200 may be opened away from each other.

The disk holder 203 in the cartridge of the information recording and reproducing apparatus of the present invention may be formed of a PET sheet or another material. As shown, for example, in FIG. 2, it is preferable that the interior of the disk holder 203 be divided into storage spaces 205 by partition sheets 204. In the example shown in FIG. 2, one optical disk 10 is stored in each storage space 205. The disk holder 203 is formed of a flexible material such as a PET sheet and has a structure as shown in FIG. 2. As a result, when the cartridge 200 closes, both ends 206 and 207 of each storage space 205 are folded, so that the disk holder 203 contracts to be housed in the cartridge 200, as shown in FIG. 2A. This structure makes it possible to thin the cartridge 200 before it is loaded in the information recording and reproducing apparatus. The thinned cartridge 200 is conveniently portable. In order that the disk holder 203 as shown in FIG. 2 can be housed easily in the cartridge 200 when the cartridge 200 closes, it is preferable that both ends 206 and 207 of each storage space 205 have creases or folds 208 as shown in FIG. 3.

When the cartridge 200 is set in the information recording and reproducing apparatus and opened, as shown in FIG. 2B, both ends 206 and 207 of each storage space 205 of the disk holder 203 expand up and down so that the interval between the optical disks 10 can widen. This action makes it easy to insert between the optical disks 10 the front ends of the arms for holding them.

For easy selection of a predetermined optical disk from the cartridge, the disk holder may be formed with physical shapes such as proper holes or concavo-convex shapes, or bar codes or IC tags at its predetermined portions. An example of the disk holder for this purpose is shown in FIG. 3, where IC tags 209 are disposed near ends 206 or 207 of the storage spaces 205. By providing such identification information in the disk holder, it is possible to select an optical disk quickly by means of an optical disk selector (309 in FIG. 3), which is provided on an end of each of the arms. Alternatively, for easy selection of a predetermined optical disk from the cartridge, each of the optical disks may have an identification code formed on its predetermined portion so that it can be discriminated.

In order to open and close the cartridge, as shown in FIG. 2, it is preferable to provide an expansion-contraction unit in the information recording and reproducing apparatus. The expansion-contraction unit makes it easy to open and close the cartridge. In the information recording and reproducing apparatus 100 shown in FIG. 1, an expansion-contraction unit 14 for opening and closing the cartridge 200 is provided on a control unit 13, as shown in FIG. 1B. FIG. 4 shows in detail the structure of the expansion-contraction unit 14 in FIG. 1B. FIG. 4 is schematic plan views of the expansion-contraction unit 14 as seen from its side adjacent to the spindle. FIG. 4A shows the state of the expansion-contraction unit 14 at the time when the cartridge is opened. FIG. 4B shows the state of the expansion-contraction unit 14 at the time when the cartridge is closed.

As shown in FIG. 4B, the expansion-contraction unit 14 shown in FIG. 4 consists of a holding plate 141, two supporting plates 142 and a drive unit 144. The holding plate 141 holds the bottom surface of the lower lid 202 of the cartridge 200. The supporting plates 142 are disposed under the holding plate 141 and support it. The drive unit 144 is provided at the end of one of the supporting plates 142 that is adjacent to the control unit 13. As shown in FIG. 4B, the supporting plates 142 are connected together at their middle position in a longitudinal direction thereof by a supporting shaft or pin 143, around which they can turn (in the direction R in FIG. 4A).

In the example shown in FIG. 1, the expansion-contraction unit 14 is controlled by a cartridge control unit 145, which is provided in the control unit 13. As shown in FIG. 4, the cartridge control unit 145 includes a motor 146 and a pinion gear 147. The pinion gear 147 is positioned in engagement with the gear of the rotating shaft of the motor 146 and the gear on the bottom of the drive unit 144 for the supporting plates 142. The rotation of the motor 146 in the cartridge controller 145 drives the pinion gear 147 to horizontally (in the direction X in FIG. 4B) move the drive 144 for the supporting plates 142 of the expansion-contraction unit 14 shown in FIG. 4. When the drive unit 144 for the supporting plates 142 moves horizontally, as shown in FIG. 4B, the supporting plates 142 turn around the supporting shaft 143 (in the direction R in FIG. 4B). This acition makes it possible to vary the height of the holding plate 141, that is, the height of the lower lid 202 of the cartridge 200. Accordingly, the use of the expansion-contraction unit 14 shown in FIG. 4 makes it easy to open and close the cartridge 200 in the information recording and reproducing apparatus.

As shown in FIG. 3, the expansion-contraction unit 14 for the cartridge 200 may be disposed to the different portion from the upper portion of the control unit 13. The position of the expansion-contraction unit for the cartridge may be arbitrary fixed according to the form of the cartridge, the method for expanding and contracting the cartridge, the positional relationships among the components in the information recording and reproducing apparatus, or the like.

It is preferable that the first and second arms of the information recording and reproducing apparatus of the present invention be identical in structure. FIGS. 5-7 show an example of the arm structure. As shown in FIG. 5, the arm 301 in the information recording and reproducing apparatus of the present invention consists of a fixed arm part 303 and a telescopic arm part 304. The telescopic arm part 304 can expand and contract in a longitudinal direction of the arm 301 (in the direction A2 in FIG. 5) relative to the fixed arm part 303. As the telescopic arm part 304 slides in the fixed arm part 303 in a longitudinal direction of the arm 301 (in the directions A2 in FIG. 6), as shown in FIG. 6, the arm 301 varies in length. FIGS. 6A and 6B show the telescopic arm part 304 as expanded in a longitudinal direction of the arm 301. FIGS. 6C and 6D show the telescopic arm part 304 as contracted in a longitudinal direction of the arm 301. The arm 301 is supported by the associated support 307 rotatably on a rotating shaft 310 in the direction A1 in FIG. 6.

It is preferable that the arm in the information recording and reproducing apparatus of the present invention has a mechanism for automatically changing the length of the arm according to the moving position of an optical disk (the rotation angle of the arm) while the arm is carrying the disk. From the viewpoint of miniaturization of the recording and reproducing apparatus, it is preferable to control the length of the arm according to the moving position of an optical disk so as to carry the disk for the shortest distance along a broken line S in FIG. 1 between the cartridge 200 and spindle 16. By thus making the arm variable in length, it is possible to carry an optical disk through a narrower space between the cartridge and spindle. Accordingly, it is possible to miniaturize the information recording and reproducing apparatus.

FIG. 7 shows a method for expanding and contracting the arm in the longitudinal direction thereof. As the arm shown in FIG. 7, a spring 311 may connect the rotating shaft 310 of the fixed arm part 303 in the arm and the end of the telescopic arm part 304 that is adjacent to the rotating shaft 310. As the arm rotates, the spring 311 expands or contracts to slide the telescopic arm part 304 relative to the fixed arm part 303, thereby continuously varying the length of the arm. Alternatively, the arm may has a thin telescopic motor therein for expanding and contracting the arm.

It is preferable that the front end of the telescopic arm part 304 be provided with a hold unit for holding an optical disk 10 while the disk is carried. An example of the hold unit is shown in FIGS. 5 and 6. The hold unit shown in FIGS. 5 and 6 includes a pair of claws 305 and 306 for holding the inner-diameter portion 30 of the optical disk 10. The claws 305 and 306 are arranged side by side in the longitudinal direction of the arm 301 on the front end of the telescopic arm part 304 of the arm. As shown in FIG. 6, the pair of claws 305 and 306 on the front end of the telescopic arm part 304 is a pair of members L-shaped in section. The horizontal parts of the L-shaped members extend away from each other in the longitudinal direction of the arm 301. With the pair of claws 305 and 306 closed (FIGS. 6A and 6C), it is inserted into the internal circle 30 of an optical disk 10. Then, as shown in FIGS. 6B and 6D, the inserted claws 305 and 306 are moved away from each other in the longitudinal direction of the arm (in the direction A3 in FIG. 6) to hold the inner-diameter portion 30 of the optical disk 10 on the horizontal parts of the L-shaped members. Additionally, for example, the claws 305 and 306 may be driven by a smoll motor, which is mounted near the rotating shaft for the fixed arm part 303 of the arm 301 and connected to the claws 305 and 306 on the front end of the arm by a wire, a thread or the like. The rotation of the small motor moves the claws 305 and 306 toward or away from each other. From the design viewpoint, when an arm having such a hold unit is used, there is need of a sufficient margin for the alignment of the inner hole of an optical disk and the front end of the arm. Therefore, it is preferable that the front end of the arm be provided with an alignment sensor such as an electrostatic sensor or the like. When the optical disk is a thin disk, which is light in weight, no problem is caused by providing the front end of the arm with such a sensor.

The hold unit provided on the front end of the arm for holding an optical disk is not limited to the pair of claws 305 and 306 shown in FIGS. 5 and 6, but may be selected out of various hold units. For example, FIG. 12 shows an arm 400 provided with another hold unit, which includes a pair of L-shaped claws 405 and 406 formed at the front end of the arm 400. The claws 405 and 406 hold an optical disk by being moved toward and away from each other in a direction perpendicular to the longitudinal direction of the arm 400 (in the direction A11 in FIG. 12). Alternatively, the front end of the arm may be provided with a grip unit for gripping the periphery of an optical disk to carry the disk.

In order to select an optical disk accurately from the cartridge of the information recording and reproducing apparatus of the present invention, it is preferable that the recording and reproducing apparatus has a drive unit (for example, a vertical drive unit 308 in FIG. 9) for moving the support for the arm vertically along the rotational axis of the spindle. It is also preferable that the information recording and reproducing apparatus has a control unit (for example, the control unit 13 in FIG. 1) for controlling the action of the arm accurately while an optical disk is carried between the cartridge and the spindle. The movement of the arm along the rotational axis of the spindle for selecting an optical disk accurately from the cartridge, loading an optical disk on the spindle and unloading an optical disk from the spindle, is controlled by the control unit through the drive unit. While an optical disk is moved between the cartridge and a position over the spindle, also, the rotating action of the arm is controlled by the control unit through the support.

An example of the operation of the information recording and reproducing apparatus of the present invention will be described briefly below with reference to FIGS. 9-11, which show the operation of the information recording and reproducing apparatus having two arms shown in FIG. 1.

While information is recorded on or reproduced from the optical disk 10A on the spindle 16, as shown in FIG. 9A, the optical disk 10B for the next recording or reproduction is held in the cartridge 200 by the first arm 301 and stands by. The description of the operation will start from this situation. First, when the information recording and reproducing apparatus is given a disk exchange command from the outside, the recording or reproducing process for the optical disk 10A ends. Then, as shown in FIG. 9B, the head 12 is moved in the direction A4 in FIG. 9B to evacuate from the optical disk 10A. Subsequently, the vertical drive unit 308 moves downward the second arm 302, which has stood by above the spindle 16. Then, the front end of the arm 302 holds the optical disk 10A and unloads it from the spindle 16 (the actions shown in FIGS. 9B-10A).

Next, as shown in FIG. 10B, the first arm 301 carries the optical disk 10B for the next recording or reproduction to over the spindle 16 and sets the carried disk on the spindle. The optical disk 10B is carried to over the spindle 16, with the first arm 301 expanding and contracting. Then, as shown in FIG. 11A, the second arm 302 is turned toward the cartridge 200 to carry the optical disk 10A, which is held by the front end of this arm, to the storage space in a predetermined position in the disk holder. The optical disk 10A is carried to the storage space, with the second arm 302 expanding and contracting. Subsequently, as shown in FIG. 11B, the head 12 is moved in the direction A9 in FIG. 11B and then starts to record information on or reproduce information from the newly set disk 10B. The series of actions of the first and second arms that is shown in the foregoing example, is controlled by the control unit 13 in FIG. 1 through the supports 307 and vertical drive units 308 for the arms.

As stated above, in the information recording and reproducing apparatus of the present invention having a plurality of arms, while information is recorded on or reproduced from a predetermined optical disk, one of the arms can be kept holding the optical disk for the next recording or reproduction and standing by. Accordingly, quick disk exchange is possible after information is recorded on or reproduced from a predetermined optical disk. This enables fast disk exchange. In particular, faster disk exchange is possible if, while information is recorded on or reproduced from a predetermined optical disk, the optical disk 10 for the next recording or reproduction stands by at the highest position over the spindle 16, as shown in FIG. 1B.

In an information recording and reproducing apparatus having a plurality of arms, it is necessary to control their action so that the action of the arm unloading an optical disk from the spindle and the action of the arm loading the optical disk for the next recording or reproduction on the spindle do not interfere with each other. The arms may be controlled by either a common control unit as shown in FIG. 1 (the control unit 13) or individual control units. When a control unit is provided for each of the arms, the control units for them need to control their actions cooperatively so that the action of the arm unloading an optical disk from the spindle and the action of the arm loading the optical disk for the next recording or reproduction on the spindle do not interfere with each other. In the case that the information recording and reproducing apparatus can be large in size, it is possible to transfer data at a higher speed by increasing the number of spindles, or increasing the number of recording-reproducing heads so that information can be transferred in parallel.

In the information recording and reproducing apparatushown in FIG. 1, because the cantilever arm carries the optical disk, it is preferable that the optical disk is light in weight.

When the optical disk is not light in weight, a pair of arms may carry one optical disk with holding it. In this case, it is preferable that the hold unit on the front end of the arm is provided with a grip unit for gripping the periphery of an optical disk instead of a pair of claws as shown in FIG. 5. In this case, it is preferable that the grip unit grips two peripheral points on an optical disk that are opposite each other with respect to the central axis of the disk. In Addition, when the optical disk is not light in weight, another pair of arms is necessary for fast disk exchange. In such an information recording and reproducing apparatus, while information is recorded on or reproduced from a predetermined optical disk, the optical disk for the next recording or reproduction is held by one pair of arms and stands by. This enables fast disk exchange.

The disk holder may not be of the integral type as shown in FIG. 2, but a disk holder may be provided for each optical disk. In such a case, disk exchange involves carrying a disk holder with an optical disk stored in it, so that the carried weight is heavy. Therefore, when a disk holder is provided for each optical disk, it is preferable that a pair of arms carry the disk holder, as stated above. When a disk holder is carried with an optical disk stored in it, the disk holder is separated from the stored disk before information is recorded on the disk. While information is recorded on or reproduced from the optical disk, the disk holder stands by beside the spindle until a storage command is given.

In the information recording and reproducing apparatus of the present invention, the arm may be provided with rollers therein. In this case, the rotation of the rollers slides the telescopic arm part relative to the fixed arm part to vary the length of the arm. An example of this arm is shown in FIGS. 13 and 14, which show the expanding and contracting action of the arm. FIG. 13 is sectional views taken along line C-C in FIG. 14, which is sectional views taken along line B-B in FIG. 13. The actions shown in FIGS. 13A-13C correspond to the actions shown in FIGS. 14A-14C, respectively. The arm 500 shown in FIGS. 13 and 14 consists of a pair of fixed arm parts 501, a telescopic arm part 502 and a plurality of rollers 503. The rollers 503 are fitted in the fixed arm parts 501. As shown in FIGS. 13 and 14, the pair of fixed arm parts 501 is fixed to a pair of vertical drive units 506, which adjusts the vertical action of the arm.

As shown in FIG. 13, the pair of fixed arm parts 501 has grooves 504 formed on their sides opposite each other. The rollers 503 are fitted at predetermined intervals on the upper and lower surfaces of the grooves 504. As shown in FIG. 13, the telescopic arm part 502 is held between the rollers 503 on the upper and lower surfaces of the grooves 504 of the fixed arm parts 501. The rotation of the rollers 503 moves the telescopic arm part 502 in a horizontal direction (in the direction A1 or A13 in FIG. 13). In the example of FIGS. 13 and 14, a spindle (not shown in the figure) is positioned under the arm. An optical disk is set on the spindle through an opening 502a of the telescopic arm part 502.

The operation of the arm shown in FIGS. 13 and 14 will be described briefly. First, as shown in FIGS. 13A and 14A, the vertical drive unis 506 move the arm 500 to the height of an optical disk to be carried. Next, as shown in FIGS. 13B and 14B, the rollers 503 in the fixed arm parts 501 are rotated in a predetermined direction to move the telescopic arm part 502 toward the cartridge 200 (in the direction A12 in FIG. 13). This action positions the telescopic arm part 502 under the optical disk to be carried. Next, the rollers 503 are rotated in the direction opposite the predetermined direction to move the telescopic arm part 502 away from the cartridge 200 (in the direction A13 in FIG. 13). This action retracts the telescopic arm part 502 together with the optical disk 10 thereon into the fixed arm parts 501, and the periphery of the optical disk is then held between the rollers 503. Under this condition, the vertical drive units 506 move downward the arm 500 to set the optical disk on the spindle.

In the information recording and reproducing apparatus of the present invention, as shown in FIG. 1, it is preferable that a shape of the disk holder end 11, from which the optical disks 10 can be taken out in the cartridge 200, is polygonal (FIG. 1) or arcuate so as not to obstruct the action of the arm.

In the information recording and reproducing apparatus of the present invention, as stated above, the arm that is variable in length can carry an optical disk between the cartridge in which optical disks are stored and the position over the spindle for recording and reproduction. It is therefore possible to provide a smaller information recording and reproducing apparatus having a higher disk exchange speed.

### BRIEF DESCRIPTION OF THE DRAWINGS

FIG. 1 is schematic diagrams of the information recording and reproducing apparatus of an embodiment. FIG. 1A is a schematic plan view. FIG. 1B is a schematic sectional view.

FIG. 2 is schematic sectional views of the cartridge as seen from its side adjacent to the spindle in the information recording and reproducing apparatus of the embodiment. FIG. 2A is a sectional view in which the cartridge is closed. FIG. 2B is a sectional view in which the cartridge is opened.

FIG. 3 is an enlarged sectional view of an end portion of the disk holder of the embodiment.

FIG. 4 is schematic diagrams of the expansion-contraction unit for the cartridge in the information recording and reproducing apparatus of the embodiment. FIG. 4A is a view showing how the cartridge is opened. FIG. 4B is a view showing how the cartridge is closed.

FIG. 5 is schematic plan views of a robot arm of the embodiment. FIG. 5A is a view showing how the claws on the front end of the robot arm are closed. FIG. 5B is a view showing how the claws on the front end of the robot arm are opened and holding an optical disk.

FIG. 6 is schematic sectional views of a robot arm of the embodiment. FIG. 6A is a view showing how the robot arm has extended, and how the claws on its front end are closed. FIG. 6B is a view showing how the robot arm is extended, and how the claws on its front end are opened and holding an optical disk. FIG. 6C is a view showing how the robot arm is contracted, and how the claws on its front end are closed. FIG. 6D is a view showing how the robot arm is contracted, and how the claws on its front end are opened and holding an optical disk.

FIG. 7 is schematic diagrams of the interior of a robot arm of the embodiment. FIG. 7A is a schematic diagram in which the robot arm is contracted. FIG. 7B is a schematic diagram in which the robot arm is extended.

FIG. 8 is a view showing how the spindle is rotating a thin MAMMOS disk used on the embodiment.

FIGS. 9A and 9B are views for the description of how to exchange disks in the information recording and reproducing apparatus of the embodiment.

FIGS. 10A and 10B are views for the description of how to exchange disks in the information recording and reproducing apparatus of the embodiment.

FIGS. 11A and 11B are views for the description of how to exchange disks in the information recording and reproducing apparatus of the embodiment.

FIG. 12 is schematic diagrams of the interior of a robot arm of a modification 1. FIGS. 12A and 12B are views showing how the claws on the front end of the robot arm are closed. FIGS. 12C and 12D are views showing how the claws on the front end of the robot arm are opened.

FIGS. 13A-13C are schematic sectional views (along line C-C in FIG. 14) of the robot arm of a modification 2, which are views for the description of how this arm carries an optical disk.

FIGS. 14A-14C are schematic sectional views (along line B-B in FIG. 13) of the robot arm of the modification 2, which are views for the description of how this arm carries an optical disk.

FIGS. 15A-15C are views showing another chucking device, which are views for the description of this device operation.

### PREFERRED FORMS EMBODYING THE INVENTION

The information recording and reproducing apparatus of the present invention will be described below in detail with reference to the drawings, but the invention is not limited to this recording and reproducing apparatus.

### EMBODIMENT

### Structure of Information Recording and Reproducing Apparatus

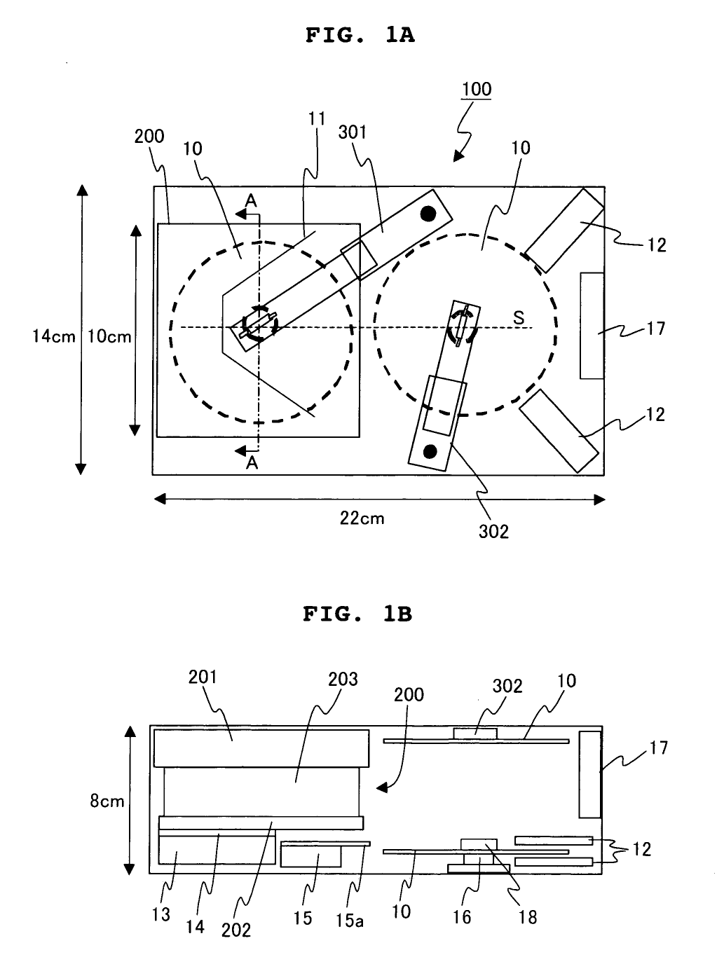

FIG. 1 is schematic diagrams of the information recording and reproducing apparatus of this embodiment. FIGS. 1A and 1B are a schematic plan view and a schematic sectional view, respectively, of the information recording and reproducing apparatus of this embodiment. The information recording and reproducing apparatus of this embodiment is an information recording and reproducing apparatus that is roughly equal in outside dimension to an LTO drive, which is a large-capacity magnetic tape. Specifically, as shown in FIG. 1, the information recording and reproducing apparatus of this embodiment has a length of 14 cm, a width of 22 cm and a height of 8 cm.

As shown in FIG. 1, the information recording and reproducing apparatus 100 of this embodiment consists mainly of a cartridge 200, recording-reproducing heads 12, a spindle 16, a first robot arm 301, a second robot arm 302, a control unit 13, an expansion-contraction unit 14, a chucking device 15 and a head control unit 17. The cartridge 200 is loaded with a plurality of optical disks 10. The recording-reproducing heads 12 record information on and reproduce information from an optical disk 10. The spindle 16 rotates an optical disk 10. The robot arms 301 and 302 carry optical disks 10 between the cartridge 200 and spindle 16. The expansion-contraction unit 14 expands or contracts the cartridge 200. The chucking device 15 attaches an optical disk 10 on or detaches an optical disk 10 from the spindle 16. The head control unit 17 controls the recording-reproducing heads 12.

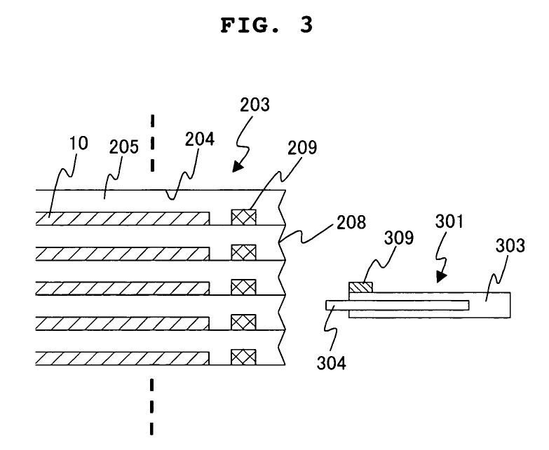

As shown in FIG. 1A, the cartridge 200 and spindle 16 are disposed away form each other so that the optical disk 10 set on the spindle 16 does not overlap with the optical disks stored in the cartridge 200. Each of the robot arms 301 and 302 is supported rotatably on a support (a support 307 as will be described later on and is shown in FIG. 3). In the plane of FIG. 1, the support parts (not shown in FIG. 1) for the robot arms 301 and 302 are disposed near the top and bottom of the information recording and reproducing apparatus 100, and relatively near the spindle 16. The supports for the robot arms are disposed so as not to overlap with the optical disk 10 set on the spindle 16 and the optical disks 10 stored in the cartridge 200.

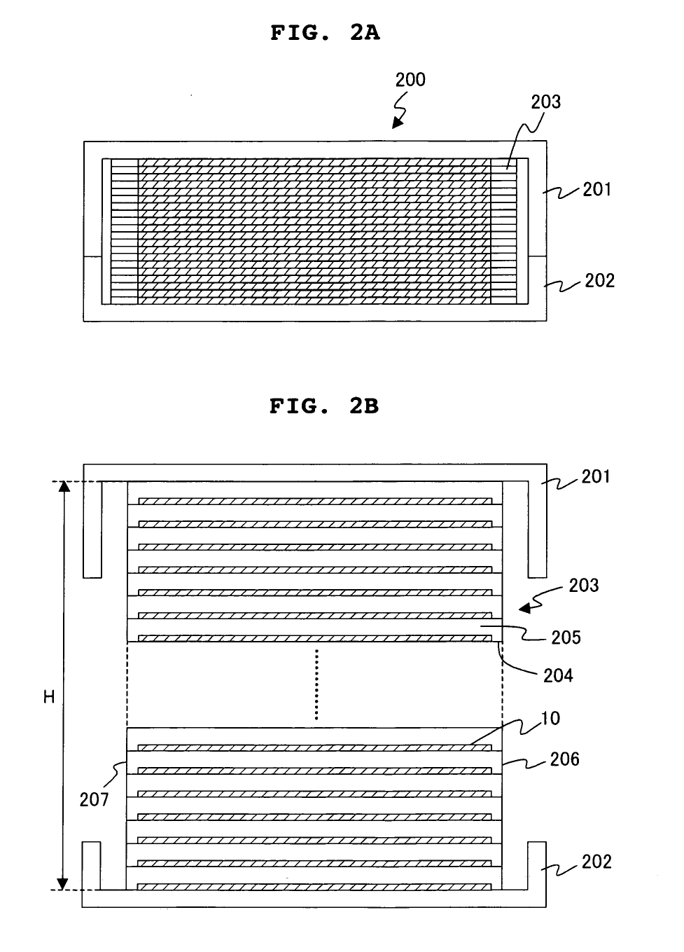

The cartridge 200 of the information recording and reproducing apparatus 100 will be described. As shown in FIG. 2, the cartridge 200 consists of a disk holder 203, an upper lid 201 and a lower lid 202. The lids 201 and 202 are fitted at the top and bottom, respectively, of the disk holder 203, in which optical disks 10 are stored. FIG. 2 is sectional views along line A-A in FIG. 1, which are schematic sectional views of the cartridge 200 as seen from its side adjacent to the spindle. FIG. 2A shows how the cartridge 200 appears before it is loaded in the information recording and reproducing apparatus 100. FIG. 2B shows how the cartridge 200 appears when it is mounted in the information recording and reproducing apparatus 100.

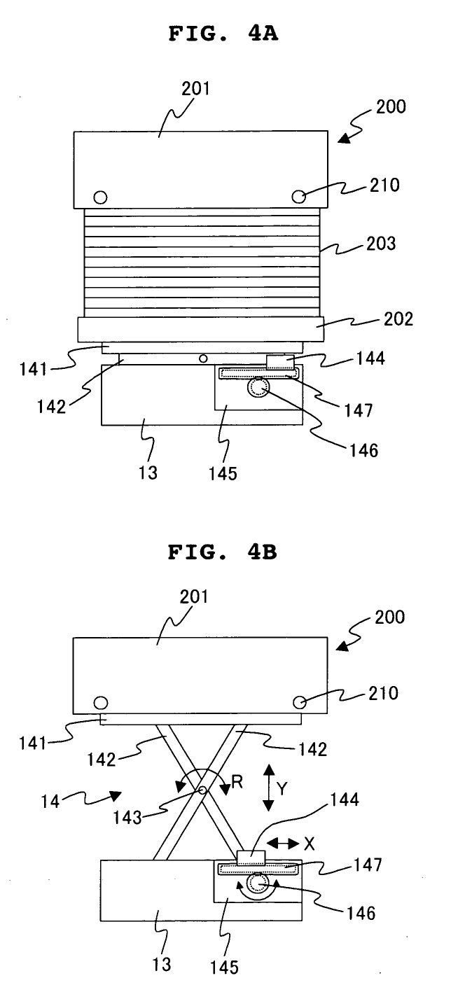

When the cartridge 200 is loaded in the information recording and reproducing apparatus 100, the locks (210 in FIG. 4) of the upper lid 201 and lower lid 201 of the cartridge 200 are released. Consequently, as shown in FIG. 2B, the lids 201 and 202 move away from each other in a direction perpendicular to the surface of the optical disk 10. In this example, the upper lid 201 is fixed, and the lower lid 202 can be moved. Therefore, the lower lid 202 moves downward by the weight of the lower lid 202, the disk holder 203 and the optical disks 10 stored in the holder, to open the cartridge 203. It is possible to close the cartridge 200, as shown in FIG. 2A, by lifting the lower lid 202 by means of an expansion-contraction unit 14, which is provided on the control unit 13 in FIG. 1 and will be described later on.

As shown in FIG. 2B, the interior of the disk holder 203 for storing the optical disks 10 loaded in the cartridge 200 is divided into storage spaces 205 by partition sheets 204. An optical disk 10 is stored in each storage space 205. The disk holder 203 is formed of a PET sheet having a thickness of 10 micrometers. As shown in FIG. 3, both ends 206 and 207 of each storage space 205 have creases or folds 208, which make it easy to house the disk holder 203 in the cartridge 200 when the cartridge is closed as shown in FIG. 2A.

As stated above, the disk holder 203 of the cartridge 200 is formed of a PET sheet, which is flexible, and both ends 206 and 207 of each storage space 205 in the disk holder 203 have creases or folds (208 in FIG. 3). As a result, when the cartridge 200 is closed, both ends 206 and 207 of each storage space 205 are folded so that the disk holder 203 can be housed in the cartridge 200, as shown in FIG. 2A. This makes it possible to thin the cartridge 200 before it is loaded in the information recording and reproducing apparatus 100. The thinned cartridge 200 is conveniently portable.

When the cartridge 200 is loaded in the information recording and reproducing apparatus 100 and opened, as shown in FIG. 2B, both ends 206 and 207 of each storage space 205 of the disk holder 203 expand up and down so that the interval between the optical disks 10 adjacent to each other in the cartridge 200 can be widened to a predetermined interval. This makes it easy to insert between the optical disks 10 the front end of the first robot arm 301 or second robot arm 302 for holding an optical disk 10. A sheet thicker than the PET sheet used in this embodiment may be used so that the interval between the optical disks 10 in the disk holder 203 could be evener when the cartridge 200 is opened as shown in FIG. 2B.

For easy selection of a predetermined optical disk 10 from the cartridge 200 of the information recording and reproducing apparatus 100, each storage space 205 of the disk holder 203 is provided with an IC tag as disk-identifying information near one of its ends, as shown in FIG. 3. In this example, as shown in FIG. 3, the front end of the robot arm 301 is provided with a module 308 for disk-authenticating radio communication, which is used to detect information on the IC tags in the disk holder 203 so as to select an optical disk.

Alternatively, the front end of the robot arm 301 may be provided with an electrostatic sensor or a photo sensor. In this case, it is possible to select an optical disk by counting in order from the top (or bottom) of the disk holder 203 the disk numbers allotted to the optical disks. In addition, when IC tag, is provided in the each storage space of the disk holder 203, as shown in FIG. 3, it is possible to compare a counted disk number with the disk number recorded on the IC tag. The comparison makes it possible to reconfirm whether the selected disk is the desired one.

In this embodiment, before the cartridge 200 is loaded in the information recording and reproducing apparatus 100, the size of the cartridge was 10 cm×10 cm×2 cm. 25 optical disks 10 were loaded in the cartridge 200. When the cartridge 200 was closed as shown in FIG. 2A, the interval between the optical disks 10 adjacent to each other in the disk holder 203 was about 760 micrometers and sufficiently larger than the thickness (about 100 micrometers) of an optical disk 10, which will be mentioned later on. When the cartridge 200 was open as shown in FIG. 2B, the length H of the disk holder 203 was 4.5 cm, and the interval between the optical disks 10 adjacent to each other in the disk holder 203 was about 1.8 mm.

FIG. 4 schematically shows the structure of an expansion-contraction unit 14, which is used to lift the lower lid 202 when closing the cartridge 200, as shown in FIG. 2A. FIG. 4 is schematic plan views of the expansion-contraction unit 14 as seen from its side adjacent to the spindle. FIGS. 4A and 4B show how the cartridge 200 is opened and closed, respectively.

As shown in FIG. 4B, the expansion-contraction unit 14 used in this example consists of a holding plate 141, two supporting plates 142 and a drive unit 144. The holding plate 141 holds the bottom surface of the lower lid 202 of the cartridge 200. The supporting plates 142 are disposed under the holding plate 141 and support it. The drive unit 144 is disposed at the end of one of the supporting plates 142 that is adjacent to the control unit 13. As shown in FIG. 4B, the supporting plates 142 are connected together at middle position in a longitudinal direction thereof by a supporting shaft or pin 143, around which they can rotate (in the direction R in FIG. 4B). The bottom surface of the drive unit 144 has concavities and convexities, which engage with a pinion gear 147 as will be described later on.

The expansion-contraction unit 14 is controlled by a cartridge control unit 145, which is provided in the control unit 13. As shown in FIG. 4, the cartridge control unit 145 includes a motor 146 and a pinion gear 147. The pinion gear 147 is disposed in engagement with the gear of the rotating shaft of the motor 146 and the concavities and convexities on the bottom surface of the drive unit 144 of the supporting plates 142.

In the expansion-contraction unit 14 of this example, the rotation of the motor 146 in the cartridge control unit 145 drives the pinion gear 147 to in horizontal direction (in the direction X in FIG. 4B) move the drive unit 144 for the supporting plates 142. When the drive unit 144 for the supporting plates 142 moves in horizontal direction (in the direction X in FIG. 4B), as shown in FIG. 4B, the supporting plates 142 turn around the supporting shaft 143 (in the direction R in FIG. 4B). This makes it possible to vary the height of the holding plate 141, that is, the height of the lower lid 202 of the cartridge 200. Accordingly, in this example, in order to change an open state of the cartridge 200 as shown in FIG. 4A to a closed state of it as shown in FIG. 4B, the motor 146 is rotated clockwise in FIG. 4 to move the drive unit 144 through the pinion gear 147 to the left in FIG. 4, thereby lifting the holding plate 141 of the expansion-contraction unit 14. The motor 146 in the cartridge control unit 145 is kept rotating until the cartridge 200 is completely closed as shown in FIG. 2B.

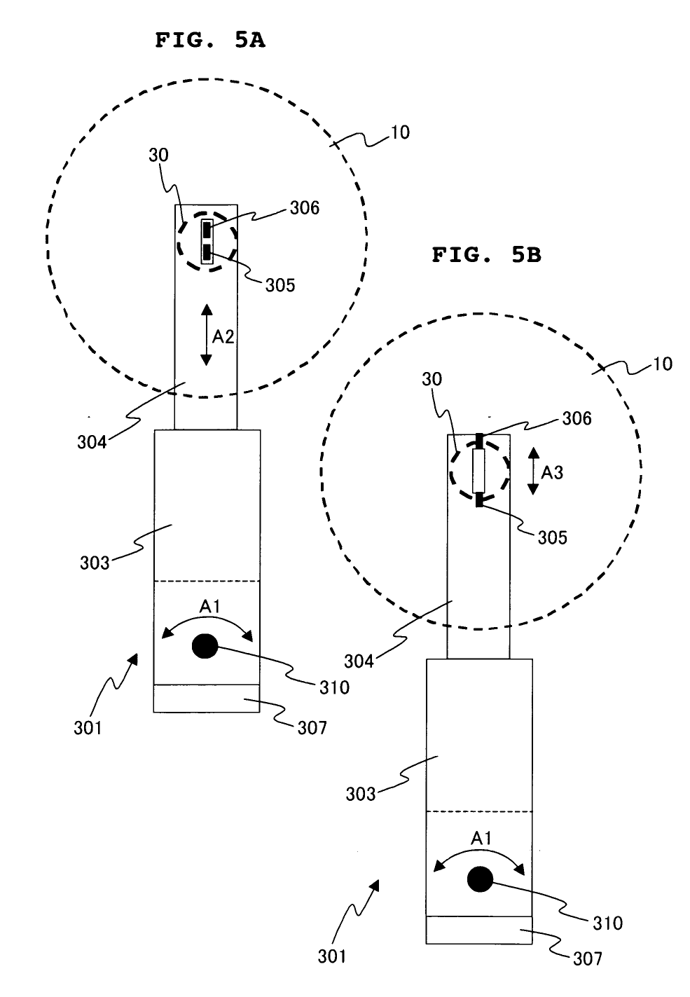

The robot arms of the information recording and reproducing apparatus 100 of this example will be described. As shown in FIG. 1, the information recording and reproducing apparatus 100 has two robot arms 301 and 302. Because the robot arms 301 and 302 are identical in structure, only the first robot arm 301 (also referred hereinafter to simply as the robot arm 301) will be described with reference to FIGS. 5-7.

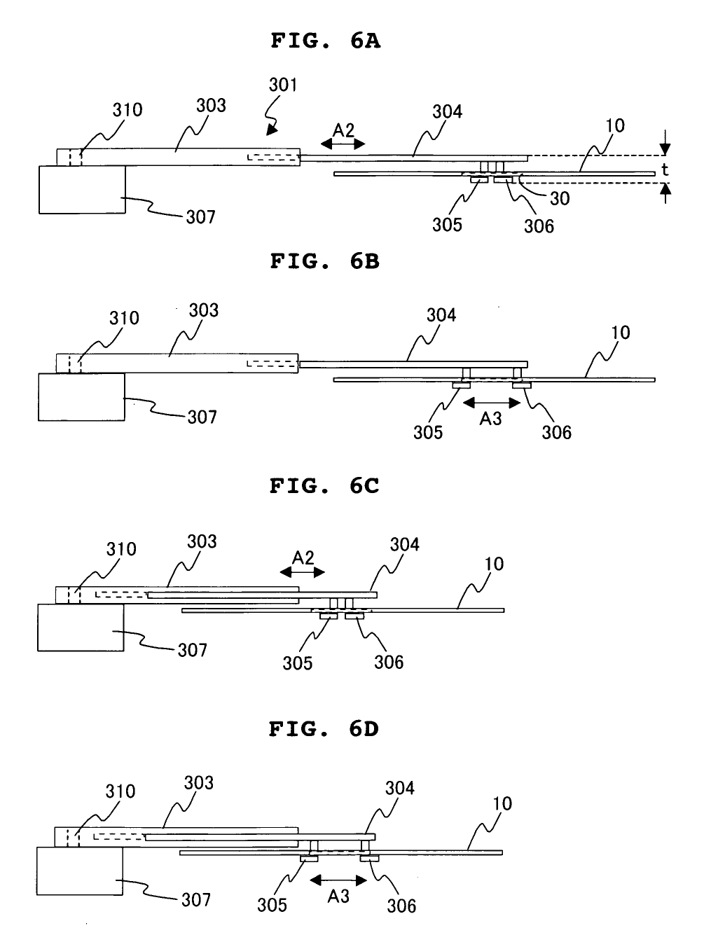

As shown in FIG. 5, the robot arm 301 of the information recording and reproducing apparatus of this example consists of a fixed arm part 303 and a telescopic arm part 304. As shown in FIGS. 5 and 6, the fixed arm part 303 of the robot arm 301 is supported on a support 307 rotatably in the direction A1 in FIG. 3. The telescopic arm part 304 can slide telescopically relative to the fixed arm part 303 in the longitudinal direction of the robot arm 301 (in the direction A2 in FIG. 5). As the telescopic arm part 304 slides in the fixed arm part 303 in the longitudinal direction of the robot arm 301 (in the direction A2 in FIG. 6), as shown in FIG. 6, the robot arm 301 varies in length. FIGS. 6A and 6B show the telescopic arm part 304 as extended in the longitudinal direction of the robot arm 301. FIGS. 6C and 6D show the telescopic arm part 304 as retracted in the longitudinal direction of the robot arm 301.

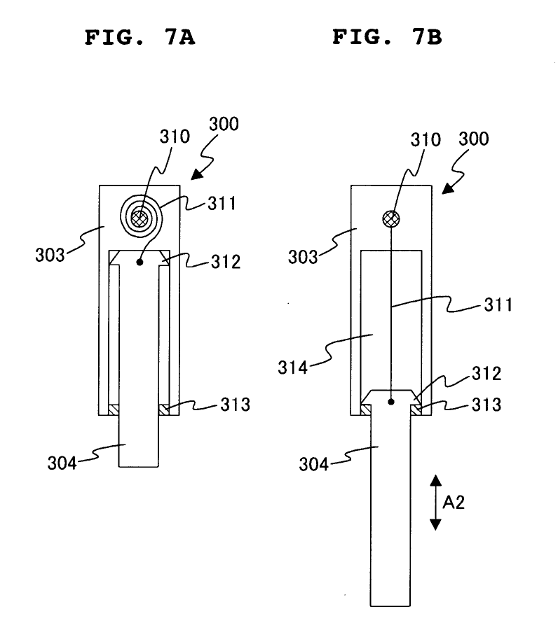

The robot arm 301 has a mechanism for varying the length of the arm automatically and continuously according to the moving position of an optical disk 10 (the rotation angle of the arm) while the robot arm 301 is carrying the optical disk 10. FIG. 7 shows a mechanism for varying the length of the robot arm 301 of this example.

FIG. 7 is schematic plan views of the interior of the robot arm 301. As shown in FIG. 7, a spring 311 connects the rotating shaft 310 of the fixed arm part 303 in the robot arm 301 and the end of the telescopic arm part 304 that is adjacent to the rotating shaft 310. As a result of such structure of the interior of the robot arm 301, the rotational movement of the robot arm 301 expands or contracts the spring 311, thereby sliding the telescopic arm part 304 in the fixed arm part 303. Thus, the rotational movement of the robot arm 301 varies the length of the robot arm 301 continuously.

In this example, when the robot arm 301 is inserted in the cartridge 200, as shown in FIG. 1, the robot arm 301 is extended as shown in FIG. 7B. While the robot arm 301 is carrying an optical disk 10 in the cartridge 200 to the spindle 16, the rotational movement of the robot arm 301 winds up the spring 311 in the arm, thereby contracting the robot arm 301. The robot arm 301 is designed so as to be short over the spindle 16, as shown in FIG. 7A. In this example, the length etc. of the spring 311 in the robot arm 301 are adjusted so that an optical disk 10 can be carried from the cartridge 200 to the spindle 16 along an orbit free of the side walls of the information recording and reproducing apparatus and the other components. Such structure of the robot arm 301 makes it possible to carry an optical disk through a narrower space between the cartridge and the spindle, so that the information recording and reproducing apparatus can be small. Because the outside dimensions of the information recording and reproducing apparatus 100 of this example are very small size, it is preferable to control the length of the robot arm 301 so that an optical disk 10 be carried for the shortest distance along the broken line S in FIG. 1.

In order to prevent the telescopic arm part 304 being off from the fixed arm part 303 when the robot arm 301 of this example has the maximum length, as shown in FIG. 7, the fixed arm part 303 has a pair of stoppers 313 formed on both side walls of the front end of the region 314 where the telescopic arm part 304 slides in the fixed arm part 303, and the telescopic arm part 304 has a pair of protrusions 312 formed on both side faces of its end adjacent to the rotating shaft 310. As a result of such structure of the interior of the robot arm 301, when the telescopic arm part 304 is extended to its maximum length as shown in FIG. 7B, its pair of protrusions 312 catch on the pair of stoppers 313 of the fixed arm part 303, so that the telescopic arm part 304 is not off from the fixed arm part 303.

As shown in FIGS. 5 and 6, the front end of the telescopic arm part 304 is provided with a pair of claws 305 and 306 for holding an optical disk 10 while the disk is carried. The claws 305 and 306 are arranged in parallel along the longitudinal direction of the robot arm 301. As shown in FIG. 6, the pair of claws 305 and 306 on the front end of the telescopic arm part 304 is formed of members L-shaped in section. The horizontal parts of the L-shaped members extend away from each other.

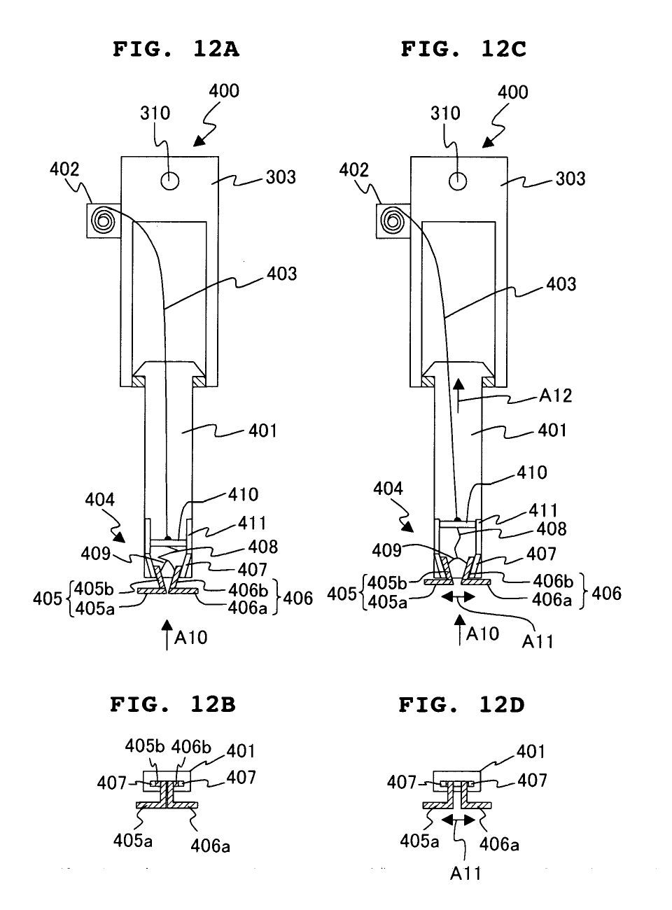

As shown in FIGS. 5 and 6, the inner-diameter portion 30 of an optical disk 10 can be held on the horizontal parts of the pair of claws 305 and 306 of the robot arm 301 of this example. The pair of claws 305 and 306 can hold an optical disk 10 by the following method. First, with the pair of claws 305 and 306, which is provided on the front end of the telescopic arm part 304, closed as shown in FIGS. 6A and 6C, the pair of claws 305 and 306 is inserted into the internal circle 30 of an optical disk 10. Then, as shown in FIGS. 6B and 6D, the inserted claws 305 and 306 are moved away from each other in the longitudinal direction of the robot arm 301 (in the directions A3 in FIG. 6) to hold the inner-diameter portion 30 of the optical disk 10 on the horizontal parts of the L-shaped members. The claws 305 and 306 were driven by a small motor (for example, small motor 401 in FIG. 12), which is mounted near the rotating shaft for the fixed arm part 303 of the robot arm 301 and connected to the claws 305 and 306 on the front end of the arm by a wire, a thread or the like (for example, wire 402 in FIG. 12). The rotation of the small motor moved the claws 305 and 306 toward and away from each other.

In this example, in order that an optical disk 10 can be taken easily out of the cartridge 200, the width (t in FIG. 6) of the front end of the robot arm 301 was 0.2 mm, which was narrower than the interval (about 1.8 mm) between the optical disks adjacent to each other in the cartridge 200, when the cartridge 200 was open (as shown in FIG. 2B). As shown in FIG. 3, the front end of the robot arm 301 is provided with an optical disk selector 308 (specifically a module for disk-authenticating radio communication) for selecting an optical disk 10 from the cartridge 200 based on the information in the IC tag (a chip for disk-authenticating radio communication) provided near one end of each storage space 205 of the disk holder 203 of the cartridge 200.

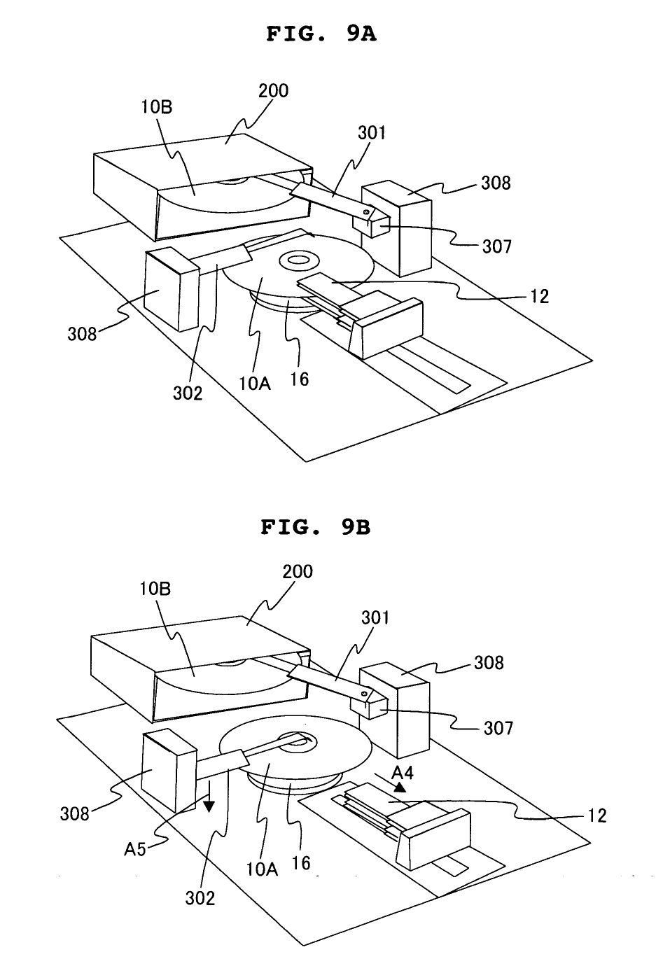

The support 307 for the robot arm 301 is attached to a vertical drive unit 308, which is shown in FIG. 9. In the information recording and reproducing apparatus of this example, the vertical drive unit 308 moves the robot arm 301 upward or downward in a perpendicular direction to the surface of the optical disk 10 so as to select an optical disk 10 accurately out of the cartridge 200 and carry the selected disk. The support 307 for the robot arm 301 has a mechanism (not shown in the figure) for controlling the rotational movement of the arm in the direction A1 in FIG. 5. This mechanism makes it possible to carry an optical disk 10 accurately between the cartridge 200 and the spindle 16.

The optical disk used in this example will be described below. The optical disk was a magnetic domain-expanding reproduction type disks (MAMMOS disks) each having a thin substrate as disclosed in Japanese Patent Application Laid-open No. 2001-35008. Specifically, the substrate was a polycarbonate disk having a diameter of 9 centimeters (cm) and a thickness of 70 micrometers. Then, on both sides of the substrate, a SiN layer (5 nanometers (nm) in thickness), a recording field assist layer (GdFeCo films having a thickness of 50 nanometers), an Al alloy layer (5 nanometers in thickness), a recording layer (TbFeCo films having a thickness of 50 nanometers), a Gd alloy layer (0.5 nanometer in thickness), an enlargement trigger layer (TbGdCo films having a thickness of 10 nanometers), an enlargement reproduction layer (GeFeCo films having a thickness of 25 nanometers) and an SiN layer (50 nanometers in thickness) were formed in that order. The stacked thin film was coated with an ultraviolet hardening resin having a thickness of 15 micrometers. The resin was then cured by ultraviolet rays. The whole thickness of the finally produced MAMMOS disk was about 100 micrometers.

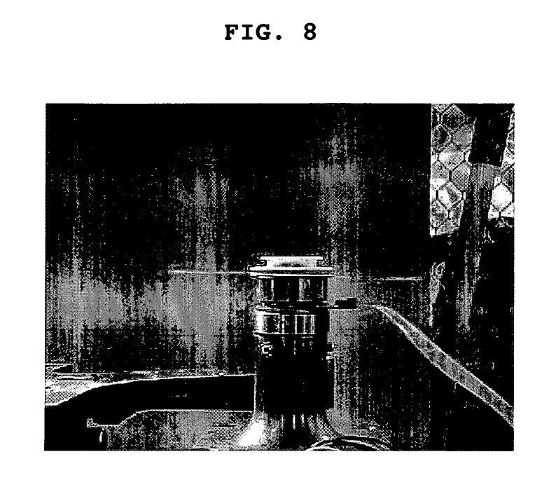

The thin MAMMOS disk thus produced was left in a hot tank at 80 degrees C. for one week, with the result that their outer shapes changed little. FIG. 8 is a photograph showing how a thin MAMMOS disk produced in this example was rotated at 1,000 revolutions. The thickness of the substrate was 70 micrometers. However, it was confirmed that the internal stresses of the stacked thin films formed on both sides of the substrate enabled the thin MAMMOS disk to rotate in a flat state at 1,000 revolutions.

The thin MAMMOS disk used in this embodiment had a bit pitch of 60 nanometers and a track pitch of 320 nanometers. The recording-reproducing head of the information recording and reproducing apparatus of this example had a laser having a wavelength of 405 nanometers and an objective lens having a numerical aperture of NA 0.90. Accordingly, the storage capacity on one side of the thin MAMMOS disk of this example is about 20 GB, and the storage capacity (on both sides) of the disk is 40 GB. In this example, because the cartridge was loaded with 25 thin MAMMOS disks, the storage capacity per cartridge is 1 TB, which is about 2.5 times the storage capacity of a conventional LTO tape (400 GB if not compressed). When 50 thin MAMMOS disks are housed in the cartridge, it has a storage capacity of 2 TB. When 100 thin MAMMOS disks are housed in the cartridge, it has a storage capacity of 4 TB. When thinner sheet substrates is used, 200 thin MAMMOS disks can conceivably be housed in the cartridge. In this case, the storage capacity is 8 TB, which is about 20 times as large as the storage capacity of a conventional LTO tape. It is possible to double (16 TB) the recording surface density of the thin MAMMOS disk, thus enabling larger capacity.

Thus, the information recording and reproducing apparatus of this example can be small, and its storage capacity can be large if the optical disk are thin MAMMOS disk. A recording-reproducing system using a conventional LTO drive can have a larger capacity by replacing this drive with the information recording and reproducing apparatus of this example, which is equal in outside dimension to the conventional LTO drive. In addition, as this example, when the information recording and reproducing apparatus of the present invention is equal in outside dimension to the conventional LTO drive, it is easily possible to construct a system including both an LTO drive and the information recording and reproducing apparatus of the present invention.

The control unit 13 in the information recording and reproducing apparatus 100 of this example includes a control unit for the recording and reproducing apparatus 100, a power supply, a motion control part for the robot arms 301 and 302, a chucking control, an expansion-contraction control for the cartridge 200 and a recorded-reproduced signal control. The head control 17 performs not only information recording-reproduction control but also focus and tracking control. In this example, as shown in FIG. 1A, two recording-reproducing heads 12 are provided in the recording and reproducing apparatus 100 in order to double the data transfer rate. In this example, one of the recording-reproducing heads 12 is used as a recording-reproducing head for lands, and the other is used as a recording-reproducing head for grooves. When one recording-reproducing head records information on and reproduces information from an optical disk on which information is recorded on lands and grooves, it is not possible to record and reproduce information under optimum phase conditions. In this example, however, the exclusive recording-reproducing heads 12 are provided for lands and grooves. Accordingly, even if information is recorded on lands and grooves of an optical disk, information can be recorded in and reproduced from the lands and grooves under optimum phase conditions. This makes it possible to widen various margins for information recording and reproduction.

### Operation of Information Recording and Reproducing Apparatus

The disk exchange operation in the information recording and reproducing apparatus of this example will be described below with reference to FIGS. 9-11. In this example, as shown in FIG. 1A, two recording-reproducing heads 12 are provided in the recording and reproducing apparatus 100. In FIGS. 9-11, however, only one recording-reproducing head 12 is shown for simplification of description. FIG. 9A shows how information is being recorded on or reproduced from both sides (sides A and B) of an optical disk 10A. Under this situation, as shown in FIG. 9A, the first robot arm 301 is holding in the cartridge 200 the optical disk 10B for the next recording or reproduction. Specifically, the optical disk 10B is held by the pair of claws 305 and 306, which is provided on the front end of the first robot arm 301 as shown in FIG. 3. In the meantime, as shown in FIG. 9A, the second robot arm 302 is standing by over the spindle 16 until the recording on or reproduction from the optical disk 10A ends.

Next, when a disk exchange command is given from the outside to the information recording and reproducing apparatus, the recording on or reproduction from the optical disk 10A is ended. Then, as shown in FIG. 9B, the recording-reproducing heads 12 is moved in the direction A4 in FIG. 9B to evacuate from the optical disk 10A. Subsequently, in order to unload the optical disk 10A from the spindle 16, the vertical drive unit 308 moves downward (in the direction A5 in FIG. 9B) the second robot arm 302 having stood by over the spindle 16. In the information recording and reproducing apparatus of this example, the optical disk was attached on and detached from the spindle motor by means of magnet chucking. Specifically, the arm 15a of the chucking device 15, which is shown in FIG. 1B, was extended to over the spindle 16, put on a magnet chuck 18 and took off the chuck. After the chucking device 15, which is shown in FIG. 1B, detaches the optical disk from the spindle motor, the pair of claws 305 and 306 on the front end of the second robot arm 302 holds the inner-diameter portion of the optical disk 10A.

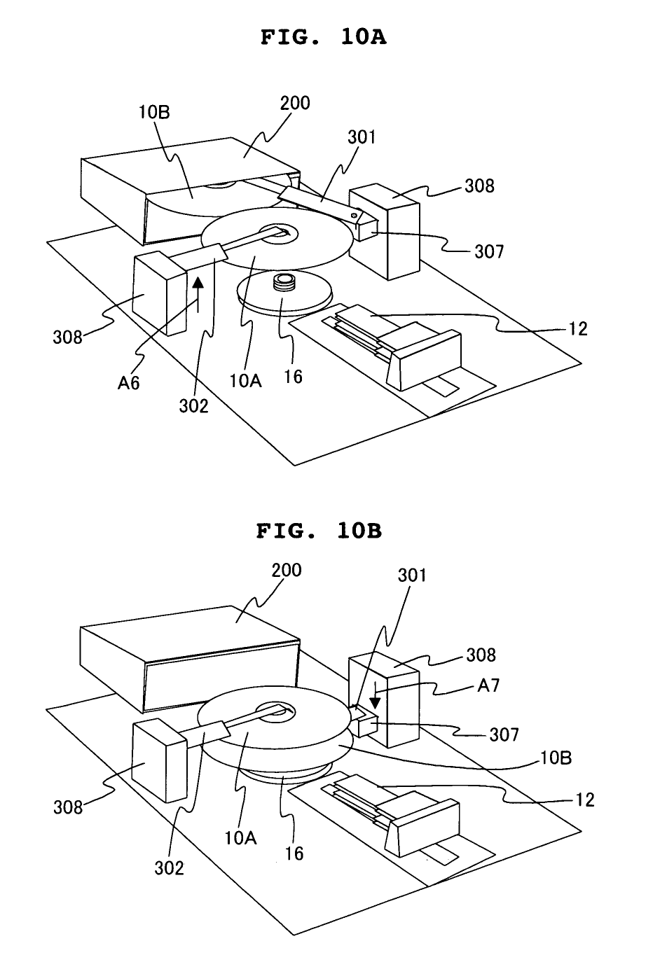

Next, as shown in FIG. 10A, the vertical drive unit 308 moves upward (in the direction A6 in FIG. 10A) to the top position over the spindle 16 the second robot arm 302 holding the optical disk 10A. Subsequently, as shown in FIG. 10B, the first robot arm 301 carries the optical disk 10B for the next recording and reproduction to over the spindle 16. While the optical disk 10B is thus carried, the first robot arm 301 turns with its length decreasing. Subsequently, the vertical drive unit 308 moves downward the first robot arm 301 (in the direction A7 in FIG. 10B) to set the optical disk 10B on the spindle 16. The chucking device 15, which is shown in FIG. 1B, chucks the set disk 10B magnetically to fix it on the spindle 16. In the meantime, as shown in FIG. 10B, the second robot arm 302 is standing by at the top position over the spindle 16.

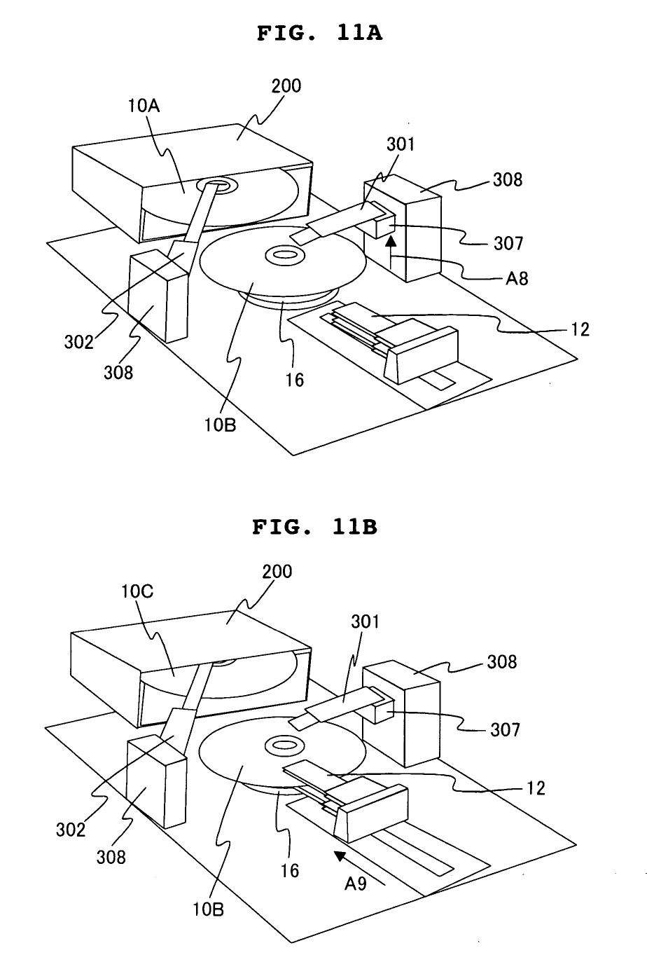

After the optical disk 10B is fixed to the spindle 16, the second robot arm 302 having stood by at the top position over the spindle 16 turns toward the cartridge 200, as shown in FIG. 11A. The rotational movement carries to the storage space at the predetermined position (where the disk 10A was stored originally) in the disk holder 203 the optical disk 10A held on the front end of the second robot arm 302. While the disk 10A is thus carried, the second robot arm 302 turns with its length increasing. Subsequently, as shown in FIG. 11B, the recording-reproducing heads 12 moves in the direction A9 in FIG. 11B and starts recording on or reproduction from the newly set disk 10B. In the meantime, as shown in FIG. 11B, the first robot arm 301 is standing by over the spindle 16, and the second robot arm 302 is standing by, holding in the cartridge 200 the optical disk 10C for the next recording or reproduction. In this example, the foregoing actions were repeated for disk exchange. During disk exchange, the control unit 13, which is shown in FIG. 1B, controlled the actions of the robot arms 301 and 302 so that each of the arms avoided interfering with the other's action. In the information recording and reproducing apparatus of this example, as stated above, disks can be exchanged by means of the two robot arms, so that the disk exchange time can be shortened.

### MODIFICATION 1

FIG. 12 is schematic diagrams of a robot arm used in the modification 1. As shown in FIG. 12, the robot arm 400 of this modification consists of a fixed arm part 303, a telescopic arm part 401, a thin and small motor 402, a hold unit 404 for holding the inner hole of an optical disk, and a wire 403. The thin and small motor 402 is provided on a side surface of the fixed arm part 303 near the fixed pin 310. The hold unit 404 is provided to the front end of the telescopic arm part 401. The wire 403 connects the thin and small motor 402 and the hold unit 404. The fixed arm part 303 is similar in structure to that of the embodiment and will not be described.

FIGS. 12A and 12C are schematic plan views of the interior of the robot arm 400 of this modification. FIGS. 12B and 12D are schematic plan views of the front end of the telescopic arm part 401 as seen in the direction A10 in FIGS. 12A and 12C, respectively. FIGS. 12A and 12B show how the hold unit 404 on the front end of the telescopic arm part 401 is closed. FIGS. 12C and 12D show how the hold unit 404 is opened to hold an optical disk at the front end of the robot arm 400.

As shown in FIG. 12, the hold unit 404 on the front end of the telescopic arm part 401 consists of a pair of claws 405 and 406, a pair of claw guides 407, a claw drive 410, a pair of drive guides 411 and a spring 409. The pair of claws 405 and 406 holds the inner hole of an optical disk. The pair of claw guides 407 guides the pair of claws 405 and 406 sliding in a longitudinal direction of the robot arm 400 (in the direction A12 in FIG. 12) in the telescopic arm part 401. The claw drive 410 is fixed to the front end of the wire 403, which extends from the thin and small motor 402. The pair of drive guides 411 guides the claw drive 410 sliding in the longitudinal direction of the robot arm 400 in the telescopic arm part 401. The spring 408 connects the claws 405 and 406 and the claw drive 410.

As shown in FIG. 12A, the pair of claw guides 407 is formed of members extending in the longitudinal direction of the robot arm 400, and is attached near both side surfaces of the telescopic arm part 401. As shown in FIG. 12A, the claw guides 407 incline symmetrically at a predetermined angle with the directions in which the robot arm 400 extends. The pair of claw guides 407 is attached so that the space between them is wider toward the rotating shaft 310 of the robot arm 400 (away from the front end of the arm).

As shown in FIG. 12A, the pair of drive guides 411 is formed of members extending in the longitudinal direction of the robot arm 400, and is attached near both side surfaces of the telescopic arm part 401. As shown in FIG. 12A, the pair of drive guides 411 is disposed nearer to the rotating shaft 310 of the robot arm 400 than the pair of claw guides 407. As shown in FIG. 12A, the pair of drive guides 411 is parallel with the directions in which the robot arm 400 extends. The claw drive 410 is disposed between the drive guides 411.

As shown in FIGS. 12A and 12B, the pair of claws 405 and 406 consists of holding parts 405a and 406a and sliding parts 405b and 406b. The holding parts 405a and 406a hold the inner hole of an optical disk. The sliding parts 405b and 406b move along the claw guides 407 in the telescopic arm part 401. As shown in FIG. 12B, the holding parts 405a and 406a of the pair of claws 405 and 406 are formed of L-shaped members. The horizontal parts of the L-shaped members extend away from each other in the perpendicular to the direction in which the robot arm 400 extends. As shown in FIG. 12A, the sliding parts 405b and 406b of the pair of claws 405 and 406 extend from the ends of the holding parts 405a and 406a, respectively, that are adjacent to the rotating shaft 310. The sliding parts 405b and 406b incline at the same angle as the claw guides 407 incline with respect to the directions in which the robot arm 400 extends. As shown in FIG. 12A, the spring 408 and the claws 405 and 406 are connected by a connector 409. The connector 409 is fixed to the ends of the claws 405 and 406 that are adjacent to the spring 408. The connector 409 connects the claws 405 and 406.

When the robot arm 400 of this modification holds an optical disk, the arm operates as follows. First, as shown in FIGS. 12A and 12B, the pair of claws 405 and 406 is inserted into the inner hole of the optical disk, with the pair of claws closed. Next, the thin and small motor 402 on the fixed arm part 303 of the robot arm 400 is driven to pull the wire 403 in the direction A12 in FIG. 12C of the robot arm 400. This action causes the claw drive 410 to slide in the direction A12 in FIG. 12C. This action also causes the claws 405 and 406, which are connected to the claw drive 410 by the spring 409 and connector 408, to slide along the pair of claw guides 407 in the direction A12 in FIG. 12C. The claw guides 407 incline so that the space between them is wider toward the rotating shaft 310 of the robot arm 400 (away from the front end of the arm). Accordingly, as shown in FIGS. 12C and 12D, the holding parts 405a and 406a of the claws 405 and 406 slide away from each other in the direction perpendicular (in the direction A11 in FIGS. 12C and 12D) to the direction in which the robot arm 400 extends. As a result, as shown in FIGS. 12C and 12D, the pair of claws 405 and 406 opens so that the inner-diameter portion of the optical disk can be held on the horizontal parts of the claws 405 and 406.

### MODIFICATION 2

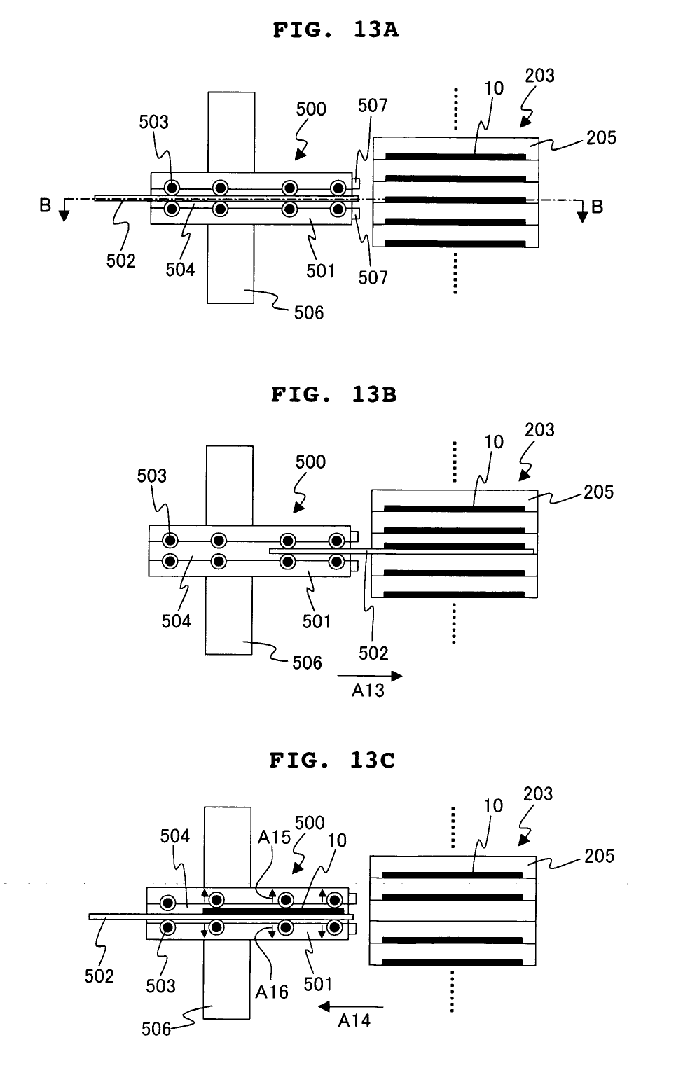

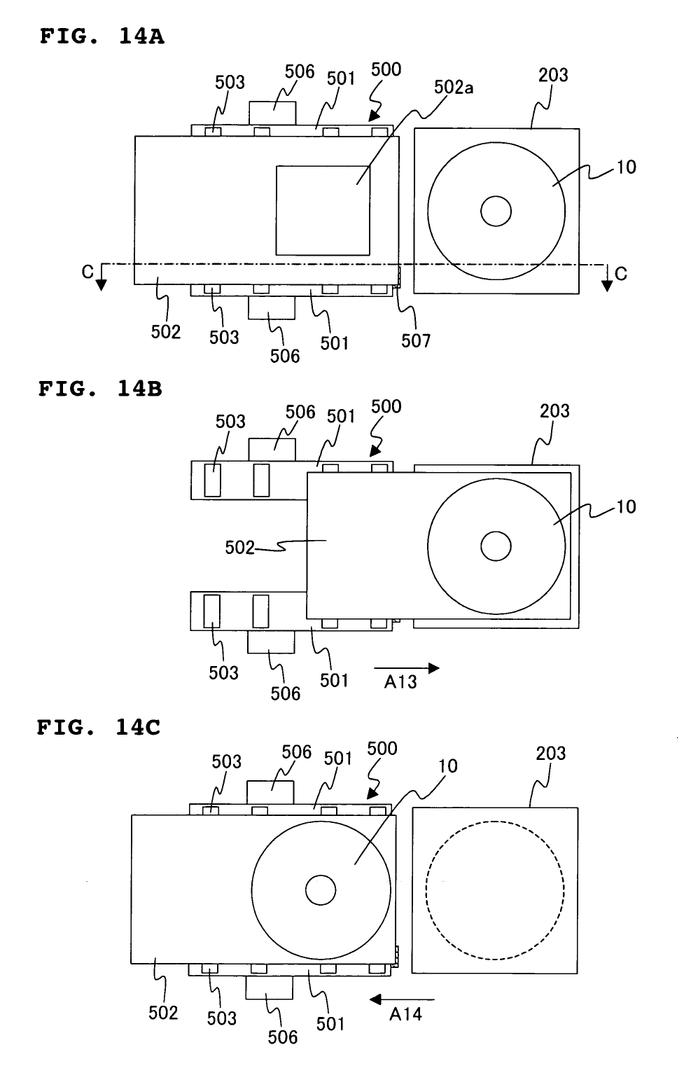

FIGS. 13 and 14 are schematic diagrams of the robot arm used in a modification 2. FIGS. 13 and 14 show the telescopic action of the robot arm. FIG. 13 is sectional views along line C-C in FIG. 14, which is sectional views along line B-B in FIG. 13. The actions in FIGS. 13A-13C correspond to those in FIGS. 14A-14C, respectively. As shown in FIGS. 13 and 14, the robot arm 500 of this modification consists of a pair of fixed arm parts 501, a telescopic arm part 502 and a plurality of rollers 503. The rollers 503 are fitted in the fixed arm parts 501. As shown in FIG. 14, the pair of fixed arm parts 501 is attached to a pair of vertical drive units 506, which adjusts the vertical action of the robot arm.

As shown in FIG. 13, the pair of fixed arm parts 501 has grooves 504 formed on their side surfaces opposite each other. The rollers 503 are fitted at predetermined intervals on the upper and lower surfaces of the grooves 504. While the robot arm 500 of this modification is carrying an optical disk 10, as will be stated later on, the telescopic arm part 502 and optical disk 10 are held between the rollers 503 on the upper and lower surfaces of the grooves 504. Accordingly, the width of the grooves 504 is larger than the whole thickness of the telescopic arm part 502 and optical disk 10. When the telescopic arm part 502 and an optical disk 10 are held between the rollers 503, as will be stated later on, it is necessary to widen the spaces between the rollers 503 on the upper and lower surfaces of the grooves 504. Therefore, the rollers 503 fitted on the upper surfaces of the grooves 504 of the fixed arm parts 501 can move upward (in the direction A15 in FIG. 13C), and the rollers 503 fitted on the lower surfaces of the grooves 504 can move downward (in the direction A16 in FIG. 13C).

As shown in FIG. 13, both side portions parallel with a longitudinal direction of the telescopic arm part 502 are held between the rollers 504 on the upper and lower surfaces of the grooves 504 of the pair of fixed arm parts 501, so that the pair of fixed arm parts 501 holds the telescopic arm part 502. The telescopic arm part 502 is held so as to be moved in a horizontal direction (in the directions A13 and A14 in FIG. 13) by the rotation of the rollers 503. As shown in FIG. 14, the telescopic arm part 502 has an opening 502a formed through a region thereof that is adjacent to the disk holder 230. In this modification, a spindle (not shown in the figure) is disposed under the robot arm 500. An optical disk can be set on the spindle through the opening 502a of the telescopic arm part 502.

In order to select an optical disk 10, one of the fixed arm parts 501 of the robot arm 500 of this modification is provided with a pair of modules 507 for disk-authenticating radio communication on its side wall surfaces adjacent to the disk holder 203, as shown in FIGS. 13 and 14.

The operation of the robot arm 500 of this modification will be described with reference to FIGS. 13 and 14. First, a desired optical disk 10 is selected by using the modules 507 for disk-authenticating radio communication, which are provided on the front end of one fixed arm part 501 of the robot arm 500, to detect the information on IC tags (209 in FIG. 3) provided in the disk holder 203. Then, as shown in FIGS. 13A and 14A, the vertical drive units 506 move the robot arm 500 to the height of the optical disk to be carried.

Next, as shown in FIGS. 13B and 14B, the rollers 503 in the fixed arm parts 501 are rotated in a predetermined direction to move the telescopic arm part 502 toward the disk holder 203 (in the direction A13 in FIG. 13). This action positions the telescopic arm part 502 under the optical disk 10 to be carried.

Next, as shown in FIGS. 13C and 14C, the rollers 503 are rotated in the direction opposite the predetermined direction to move the telescopic arm part 502 away from the disk holder 203 (in the direction A14 in FIG. 13). This action brings the telescopic arm part 502 together with the optical disk 10 thereon into the space between the fixed arm parts 501, where the optical disk is then held between the rollers 503.

Next, with the optical disk held between the rollers 503, as shown in FIGS. 13C and 14C, the vertical drive units 506 moves downward the robot arm 500 to set the optical disk on the spindle (not shown in the figure). As shown in FIG. 14, the telescopic arm part 503 of the robot arm 500 of this modification has an opening 502a formed through a portion thereof on which an optical disk 10 is placed. Accordingly, by moving downward the robot arm 500 by means of the vertical drive units 506, it is possible to set an optical disk 10 on the spindle.

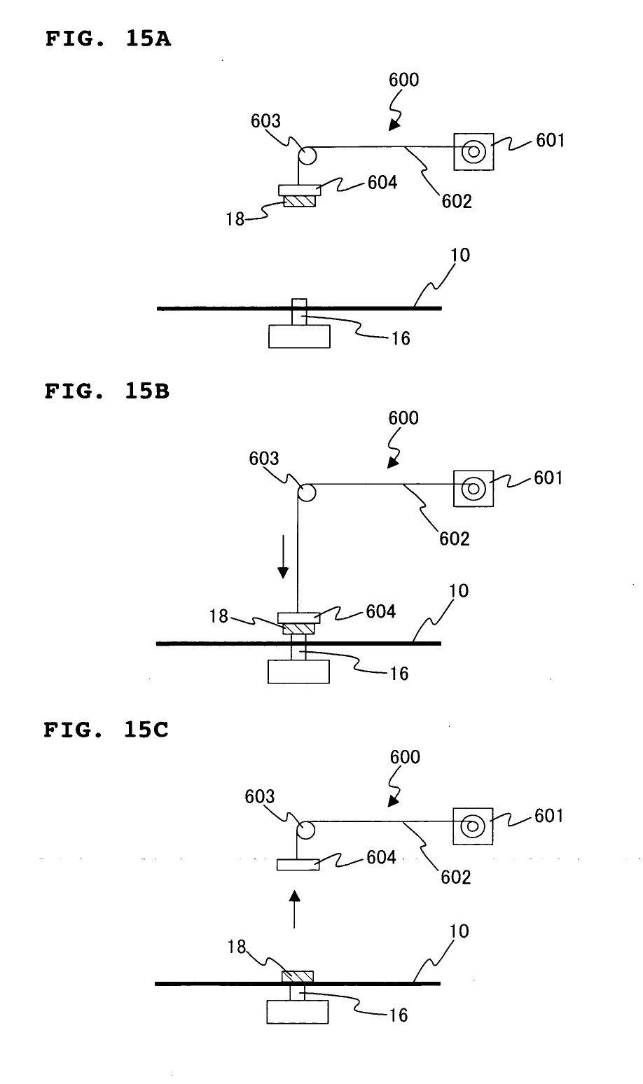

In the foregoing embodiment, when an optical disk is loaded on or unloaded from the spindle motor, the arm 15a of the chucking device 15, which is shown in FIG. 1B, is extended to over the spindle to put on or take off the magnet chuck 18. However, the present invention is not limited to this. For example, a chucking device 600 as shown in FIG. 15 may be used. As shown in FIG. 15, the chucking device 600 consists of a motor 601, a pulley 603, a magnet chuck holder 604 and a wire 602, which connects the motor 601 and magnet chuck holder 604 through the pulley 603. As shown in FIG. 15, the magnet chuck 18 is hung in a vertical direction (in the direction of the rotational axis of the spindle 16) by the wire 602 through the pulley 603 and magnet chuck holder 604. As shown in FIGS. 15A to 15C, the rotation of the motor 601 extends or pulls the wire 602 to put on or take from the spindle 16 the magnet chuck 605 hung by the wire 602.

In the information recording and reproducing apparatus of this example, as stated above, the robot arms for carrying optical disks can vary in length. This structure makes it possible to carry optical disks across less space between the cartridge and the spindle, thereby enabling the information recording and reproducing apparatus to be smaller. By using a plurality of robot arms, it is possible to speed up the series of disk exchange actions for selecting an optical disk from the cartridge, which contains optical disks, and carrying the selected disk. The cartridge, which is loaded with optical disks, can expand and contract in the direction perpendicular to surface of of the optical disk. This structure makes it possible to thin the cartridge before it is loaded in the information recording and reproducing apparatus. The thinned cartridge is conveniently portable. By considering the sizes of the cartridge and optical disks, it is possible to make the cartridge and the disks large in capacity. Accordingly, the information recording and reproducing apparatus of the present invention can be small in size, high in disk exchange speed and large in capacity, and is therefore suitable as a recording-reproducing system for the next generation. Accordingly, the present invention can be applied to not only optical disks but also magnetic disks.

A recording-reproducing system using a conventional LTO drive can have a larger capacity by replacing this drive with the information recording and reproducing apparatushown in the foregoing embodiment, which is equal in outside dimension to the conventional LTO drive. In addition, as the foregoing embodiment, when the information recording and reproducing apparatus of the present invention is equal in outside dimension to the conventional LTO drive, it is possible to construct a new recording-reproducing system including both an LTO drive and the information recording and reproducing apparatus of the present invention.

1. An information recording and reproducing apparatus comprising:
a cartridge in which a plurality of optical disks are loaded;
a head which records information on and reproduces information from one of the optical disks;
a spindle which rotates the optical disk; and
a first arm which carries the optical disk between the cartridge and the spindle, and which expandable and contractible in a longitudinal direction thereof.

2. The information recording and reproducing apparatus according to claim 1, further comprising a first support unit which supports the first arm, a first drive unit which moves the first arm in a direction of a rotational axis of the spindle, and a first control unit which controls an action of the first arm through the first support unit and the first drive unit when the optical disk is carried between the cartridge and the spindle.

3. The information recording and reproducing apparatus according to claim 1, wherein a front end portion of the first arm is provided with a first hold unit which holds the optical disk.

4. The information recording and reproducing apparatus according to claim 1, wherein a thickness of a front end portion of the first arm is thinner than an interval between the optical disks adjacent to each other in the cartridge.

5. The information recording and reproducing apparatus according to claim 1, further comprising a second arm which carries the optical disk between the cartridge and the spindle.

6. The information recording and reproducing apparatus according to claim 5, further comprising a second support unit which supports the second arm, a second drive unit which moves the second arm in the direction of the rotational axis of the spindle, and a second control unit which controls an action of the second arm through the second support unit and the second drive unit when the optical disk is carried between the cartridge and the spindle.

7. The information recording and reproducing apparatus according to claim 5, wherein a front end portion of the second arm is provided with a second hold unit which holds the optical disk.

8. The information recording and reproducing apparatus according to claim 5, wherein a thickness of the front end portion of the second arm is thinner than the interval between the optical disks adjacent to each other in the cartridge.

9. The information recording and reproducing apparatus according to claim 5, wherein, while information is recorded on and/or reproduced from a predetermined optical disk, the first and second control units control the actions of the first and second arms, respectively, so that one of the arms holds the optical disk for the next recording and/or reproduction and stands by.

10. The information recording and reproducing apparatus according to claim 5, wherein, while the optical disks are exchanged, the first and second control units cooperate with each other to control the actions of the first and second arms, respectively, so that each of the arms avoids interfering with the other's action.

11. The information recording and reproducing apparatus according to claim 1, wherein the optical disk is a optical disk used in a magnetic domain-expanding reproduction system.

12. An information recording and reproducing apparatus comprising:
a cartridge in which a plurality of optical disks are loaded;
a head which records information on and reproduces information from one of the optical disks;
a spindle which rotates the optical disk; and
a first arm which carries the optical disk between the cartridge and the spindle;
the cartridge is expandable and contractible in a direction of a rotational axis of the spindle.

13. The information recording and reproducing apparatus according to claim 12, further comprising an expansion-contraction unit which expands and contracts the cartridge, and a cartridge control unit which controls the expansion and contraction of the cartridge through the expansion-contraction unit when the cartridge is loaded into and unloaded from the information recording and reproducing apparatus.

14. The information recording and reproducing apparatus according to claim 12, further comprising a first support unit which supports the first arm, a first drive unit which moves the first arm in a direction of a rotational axis axis of the spindle, and a first control unit which controls the action of the first arm through the first support unit and the first drive unit when the optical disk is carried between the cartridge and the spindle.

15. The information recording and reproducing apparatus according to claim 12, wherein a front end portion of the first arm is provided with a first hold unit which holds the optical disk.

16. The information recording and reproducing apparatus according to claim 12, wherein a thickness of the front end portion of the first arm is thinner than an interval between the optical disks adjacent to each other in the cartridge.

17. The information recording and reproducing apparatus according to claim 12, further comprising a second arm which carries the optical disk between the cartridge and the spindle.

18. The information recording and reproducing apparatus according to claim 17, further comprising a second support unit which supports the second arm, a second drive unit which moves the second arm in the direction of the rotational axis of the spindle, and a second control unit which controls an action of the second arm through the second support unit and the second drive unit when the optical disk is carried between the cartridge and the spindle.

19. The information recording and reproducing apparatus according to claim 17, wherein a front end portion of the second arm is provided with a second hold unit which holds the optical disk.

20. The information recording and reproducing apparatus according to claim 17, wherein a thickness of the front end portion of the second arm is thinner than the interval between the optical disks adjacent to each other in the cartridge.

21. The information recording and reproducing apparatus according to claim 17, wherein, while information is recorded on and/or reproduced from a predetermined optical disk, the first and second control units control the actions of the first and second arms, respectively, so that one of the arms holds the optical disk for the next recording and/or reproduction and stands by.

22. The information recording and reproducing apparatus according to claim 17, wherein, while the optical disks are exchanged, the first and second control units cooperate with each other to control the actions of the first and second arms, respectively, so that each of the arms avoids interfering with the other's action.

23. The information recording and reproducing apparatus according to claim 12, wherein the optical disk is an optical disk used in a magnetic domain-expanding reproduction system.
